(19) United States
(12) Patent Application Publication
(10) Pub. No.: US 2004/0037162 A1
(43) Pub. Date: Feb. 26, 2004

(54) Vortex generator with controlled wake flow

(76) Inventors: Peter Flohr, Birmenstorf (CH); Ephraim Gutmark, Cincinnati, OH (US); Bettina Paikert, Oberrohrdorf (CH); Christian Oliver Paschereit, Baden (CH)

Correspondence Address: Law Office of Adam J. Cermak, P. O. Box 7518, Alexandria, VA, 22307, US

(21) Appl. No.: 10/621,379

(22) Filed: Jul. 18, 2003

(30) Foreign Application Priority Data
Jul. 20, 2002 (DE) 102 33 111.1

(51) Int. Cl. B01F 5/06

(52) U.S. Cl. 366/181.5; 366/337

(57) ABSTRACT

The invention relates to a vortex generator in a flow duct to which a fluid medium is applied, as well as method for controlling the wake flow of such a vortex generator. The task of safely avoiding the formation of a return flow zone in the core of the wake vortex (11) even under changing flow conditions is realized according to the invention in that an axial impulse is introduced in a targeted manner into the core flow of the wake vortex (11). According to a preferred embodiment of the invention, for this purpose a secondary flow is introduced at least approximately in the direction of the main flow into the core flow of the wake vortex (11) via outlet openings (12) on the vortex generator (2).

### FIELD OF TECHNOLOGY

The invention relates to a vortex generator in a flow duct to which a fluid medium is applied, as well as method for controlling the wake flow of such a vortex generator. A special field of application of the invention is the swirling and intermixing of fuel/air mixtures in premix burners.

### STATE OF THE ART

There are many designs of static mixers for reducing the mixing length of flowing fluid media.

One design of such mixers that permits an intensive mixing of flowing fluid media with relatively little loss of pressure is the subject matter of EP 0 623 786. The static mixers, called from hereon vortex generators, discussed in this reference, represent tetrahedron-like bodies arranged on at least one mantle surface of a flow duct to which a fluid medium is applied. They comprise three active surfaces extending in the flow direction, surfaces around which flow occurs freely, namely a top surface oriented into the flow duct, and two side surfaces. The side surfaces connected with the wall of the flow duct enclose a sweepback angle α between themselves, whereas the top surface extends at an angle of pitch θ to the duct wall.

By generating longitudinal vortices without a recirculation zone, a rough intermixing is achieved even after an extremely short mixing length of one vortex rotation, while a fine intermixing is achieved as a result of the turbulent flow after a length of only a few duct heights.

These vortex generators are characterized by a special simplicity both with respect to their manufacture as well as their technical effectiveness. The manufacture and assembly of the three active surfaces as well as their connection with a level or curved duct wall may be achieved without problems using simple joining methods, usually by welding. From the standpoint of fluidics, these generators have very little loss of pressure and, if designed accordingly, generate wake vortices without a stagnant zone. Size and force of the wake vortices are functions of element height h, element length l, angle of pitch θ, as well as sweepback angle α.

Thus a variation of these parameters represents a simple means for aerodynamically stabilizing a flow.

With relatively large angles of pitch θ and/or sweepback angles α, the vortex force of the wake vortices increases to such a degree that in their core a zone with a lower flow speed forms, which in the presence of changing flow conditions carries the risk of a breakdown of the vortex while forming a return flow. The design of the vortex generators therefore always presents a compromise of, on the one hand, making the vortices so strong that a maximum intermixing of the involved components takes place in the shortest possible wake, yet, on the other hand, not making the vortices so strong that a zone with a lower flow speed or even a return flow forms in the core.

Since the incorporation of these vortex generators in the flow path is a matter of equipment measures, they are unchangeable once installed. This means that an active influence on permanently or temporarily changed flow conditions is not easily possible.

Especially when these vortex generators are used in modern gas turbine systems for intermixing and swirling a fuel/air mixture, this behavior may have negative effects on the flame stability and may result in an undesired shifting of the flame position.

### DESCRIPTION OF THE INVENTION

In a further development of said state of the art, the invention is based on the task of providing a vortex generator that avoids said disadvantages and safely excludes the formation of a return flow zone in the core of the wake vortex even under changing flow conditions in the flow duct and thus makes it possible to expand the range of use and the variability of these vortex generators. The invention is further based on the task of providing a method for controlling the wake flow of such vortex generators.

According to the invention, these tasks are realized with a vortex generator and a method according to the type mentioned in the primary claims.

The secondary claims represent advantageous embodiments of the vortex generator and of the method.

The basic concept of the invention consists of increasing the axial speed in the vortex core through a targeted introduction of an axial impulse into the core flow of the wake vortex.

According to a preferred embodiment of the invention, this axial impulse is added by introducing a secondary flow that is oriented at least approximately in flow direction into the immediate zone of the core flow.

In a preferred embodiment, one of the components to be mixed is added as a secondary flow into the flow duct.

It was hereby found to be advantageous to introduce the secondary flow via outlet openings on the vortex generator into the core flow of the wake vortex. In a useful manner, the outlet openings of the secondary medium are positioned in the area of the side surfaces of the vortex generator or at its downstream edge.

According to one especially advantageous embodiment, the outlet hole is located at half of the chord length of the side surface below the trailing edge.

The secondary flow hereby can be introduced into the core flow from a single opening on the vortex generator or from a plurality of outlet openings oriented towards the vortex core.

According to a useful supplement to the invention, it is further suggested to use the cooling holes at or near the vortex generators in a targeted manner for introducing an additional axial impulse. This can be achieved by modifying part of the cooling holes in such a way that an increased axial impulse is introduced into the core flow of the wave vortices. For this purpose, the geometry of the outlet openings is configured accordingly, for example with respect to their orientation and/or throughput.

The measures according to the invention are also without difficulty suitable as a retrofit measure for retrofitting already installed vortex generators according to the state of the art by providing corresponding outlet openings as well as means for adding a secondary fluid into the hollow inner space of the vortex generators. Vortex generators that have already been equipped for cooling and admixture purposes with means for adding a secondary fluid as well as with outlet openings may be retrofitted with a modified design of the geometry of the outlet openings (FIGS. 4b; 5b).

By making the amount of secondary fluid that can be added variable, the invention makes it possible to react actively to temporarily or permanently changed flow conditions.

The mass flow of the secondary flow is hereby very small. It is in the magnitude between 0.1% and 5%, in particular between 0.5% and 1.5%, related to the total mass flow.

### BRIEF DESCRIPTION OF DRAWINGS

Other features, advantages, and details of the invention will be explained below in reference to the drawings. Only those elements essential to the invention are shown. Identical or corresponding elements are designated with the same reference numerals.

Hereby:

FIG. 1 shows a vortex generator according to the state of the art

FIG. 2 shows a velocity field (standardized axial speed) of a duct flow in the wake of a vortex generator according to the state of the art

FIG. 3 shows a principal drawing of the function of the invention

FIG. 4a,b show a first embodiment of a vortex generator according to the invention

FIG. 5a,b show another embodiment of a vortex generator according to the invention

FIG. 6 shows a velocity field (standardized axial speed) of a duct flow in the wake of a vortex generator according to the invention

FIG. 7 shows the mass-averaged vortex force downstream from the vortex generator

### WAYS OF EXECUTING THE INVENTION

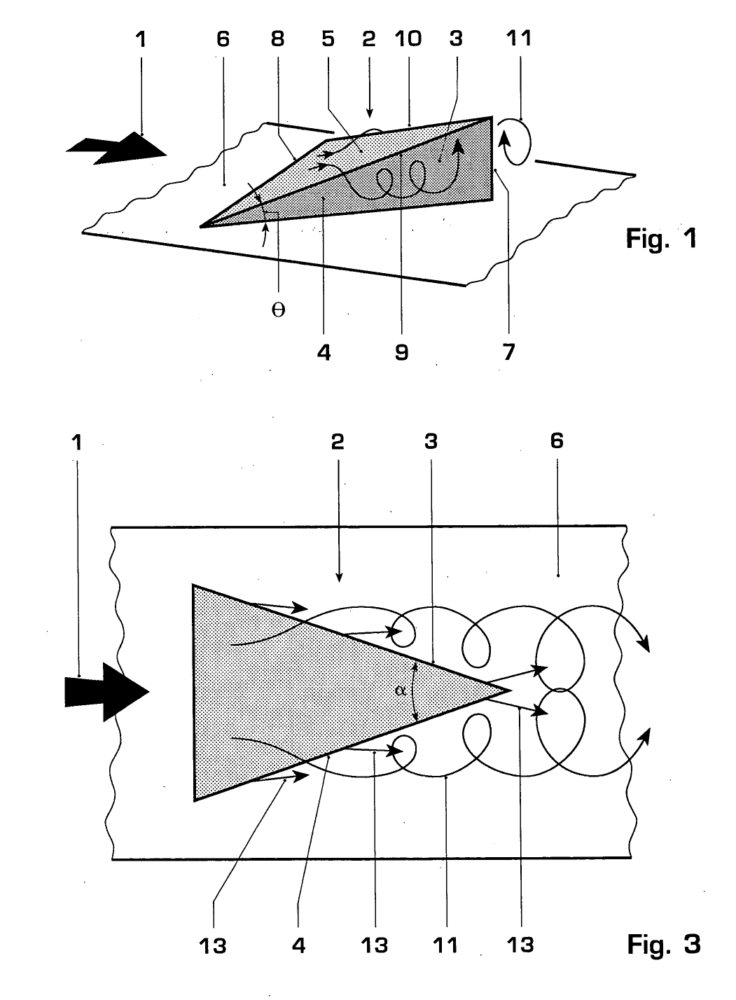

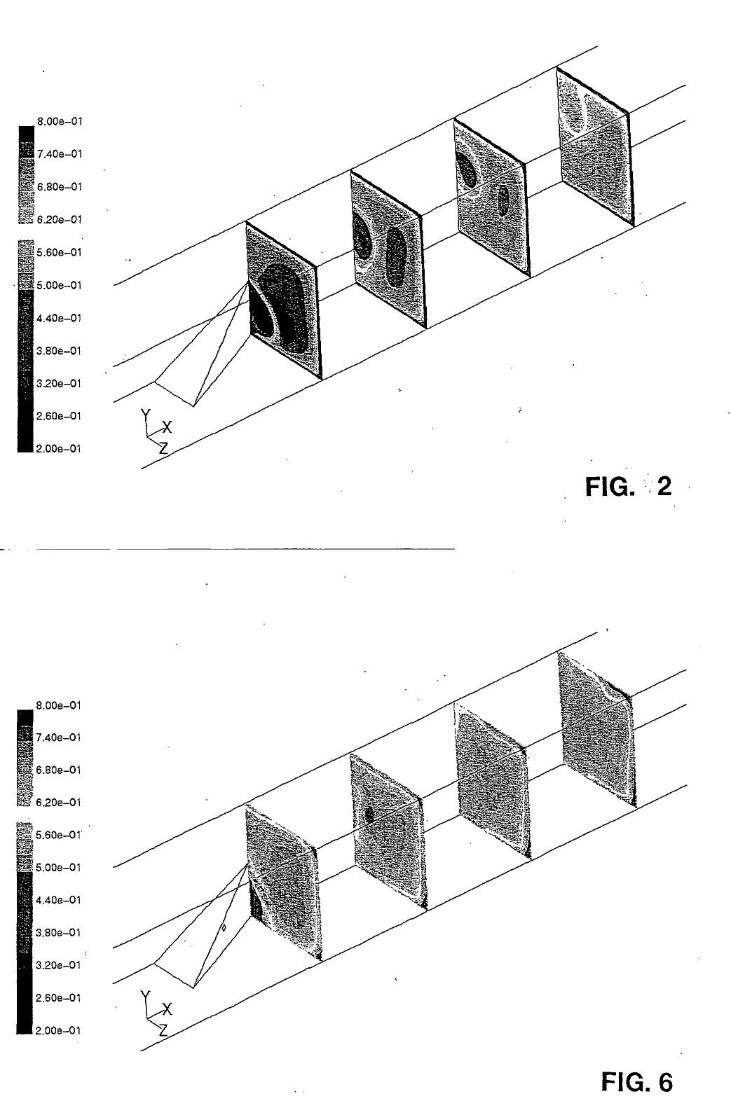

FIGS. 1 and 2 show in a principal manner the function of a vortex generator (2) according to the state of the art to which a flow (1) is applied.

Such a vortex generator (2) has three surfaces extending in flow direction around which flow occurs freely, namely two side surfaces (3) and (4) as well as a top surface (5) that is perpendicular to them, whereby the side surfaces (3) and (4) form a right-angled triangle and the top surface (5) an isosceles triangle. The side surfaces (3) and (4) extend essentially perpendicular to the duct wall (6), which is not an obligatory requirement, and are fixed with one of their cathetus sides to the duct wall (6), preferably in a gas-tight manner. They are oriented in such a way that they meet with the second cathetus sides at a connecting edge (7) while enclosing a preferably acute sweepback angle α, where said connecting edge (7) simultaneously represents the downstream end of the vortex generator (2) and is oriented perpendicular to the duct wall (6). The side surfaces (3) and (4) have dimensions that provide them with an essentially identical coverage. Their hypotenuse sides that extend at an increasing distance to the duct wall (6) in flow direction support the top surface (5) that is at an acute angle of pitch θ relative to the duct wall (6). The top surface contacts the duct wall (6) with a connecting edge (8) that extends transversely to the flow direction. The flush connecting edges between the two side surfaces (3) and (4) and the top surface (5) form trailing edges (9) and (10).

The symmetry axis of the vortex generators (2) is oriented parallel to the flow direction.

Naturally, the vortex generator (2) also may be provided with a bottom surface, with which it is fixed in a suitable manner to the duct wall (6). However, such a bottom surface is not related to the function of the vortex generator.

The function of the vortex generator (2) is essentially the one described in the following. A duct flow (1) flows towards the vortex generator (2) and is deflected by its top surface (5). Due to the abrupt increase in cross-section when flowing over the trailing edges (9) and (10), a pair of countercurrent wake vortices (11) forms, the axes of which are located in the axis of the main flow. Vortex force and swirl value are determined decisively by the angle of pitch 0 and the sweepback angle α. Vortex force and swirl value increase with larger angles, and in the core of the wake vortices, immediately behind the vortex generator (2), a zone with a lower axial speed (dark areas in FIG. 2) forms increasingly, which may lead to a vortex breakdown.

FIG. 3 shows the basic principle of the described solution in a very schematic manner. Starting from a suitable location on the vortex generator (2), an axial impulse for influencing the core flow is introduced into the wake vortex (11). A secondary flow (13) hereby causes an additional impulse to be generated near the vortex core, an impulse which is drawn by the inductive effect of the swirl flow into the zone of the vortex core. If the impulse directs itself parallel to the main flow, the vortex (11) stabilizes and the wake flow is accelerated. The vortex breakdown is delayed and is shifted downstream.

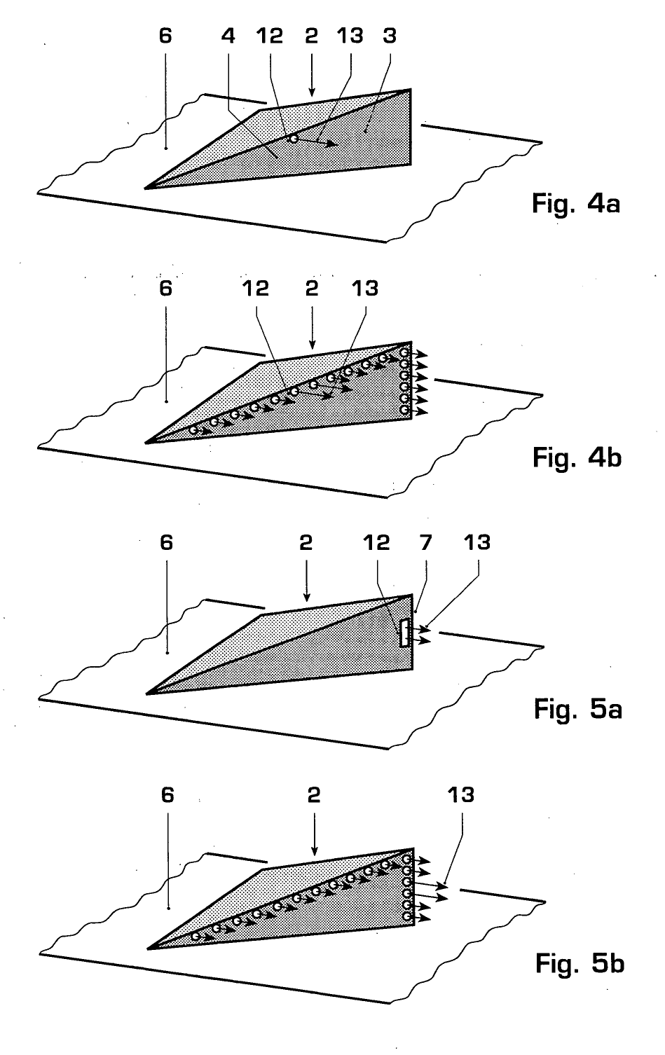

According to a preferred embodiment according to FIG. 4, the vortex generator (2) is equipped for this purpose with at least one outlet opening (12) for a fluid medium in the area of the side surface (3). The outlet opening (12) is hereby arranged and oriented in such a way, for example at half of the chord length below the trailing edge (9), that the exiting fluid jet (13) penetrates into the core flow of the wake vortex (11) and reinforces the axial speed in this zone. By increasing the flow speed in the core zone of the wake vortex (11), the location of the vortex breakup is shifted downstream.

FIG. 5 shows in a schematic manner an alternative possibility for introducing a secondary flow. According to this, the at least one outlet opening (12) for introducing the secondary flow is located in the area of the downstream connecting edge (7) of the vortex generator (2). This may be a circular outlet opening (12) at half the height of the vortex generator (2), a plurality of such openings in this area, or a slit-shaped outlet opening (12).

As can be seen from FIG. 6, the result of the targeted injection of a secondary fluid into the vortex core flow is a clearly more stabile velocity field in the wake of the vortex generator (2).

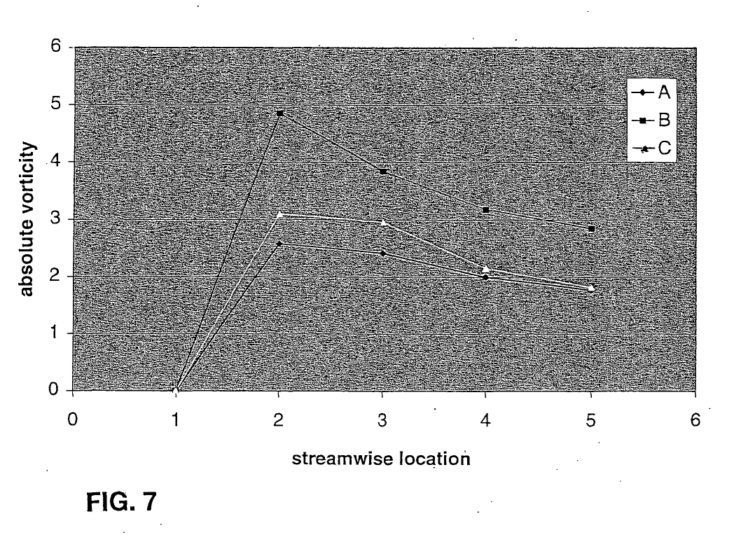

FIG. 7 shows that, in spite of an acceleration of the vortex core, the vortex force is not weakened. In the described example, the mass-averaged vortex force downstream from the vortex generator even increases by up to 50%. Variation A hereby represents the reference case of a vortex generator with such a steep angle of pitch that a zone of low flow speed is created in the wake. Variations B and C represent the conditions for a vortex generator according to the invention, in which a secondary flow is applied at half the chord length of one side surface (variation B) or at the downstream connecting edge (variation C).

It is advantageous that the vortex generators (2) are located symmetrically and parallel to the flow direction. This creates vortices (11) with identical swirls.

Regardless of this, the scope of the invention naturally also includes an asymmetrical design of the vortex generators (2), for example in the form of a half vortex generator where only one of the two side surfaces (3) or (4) is fixed at a sweepback angle α/2 to the duct wall (6), whereas the other side surface (3) or (4) is oriented parallel to the flow direction. In contrast to the symmetrical vortex generator (2), only one wake vortex (11) is generated on the swept-back side rather than a pair of countercurrent vortices (11). As a result, a swirl is forced on the main flow (1).

LIST OF REFERENCE NUMERALS

| | |
|---|---|
| 1 | Main flow |
| 2 | Vortex generator |
| 3 | Side surface |
| 4 | Side surface |
| 5 | Top surface |
| 6 | Duct wall |
| 7 | Connecting edge |
| 8 | Connecting edge |
| 9 | Trailing edge |
| 10 | Trailing edge |
| 11 | Wake vortex |
| 12 | Outlet opening |
| 13 | Secondary flow |

1. Vortex generator in a flow duct to which a fluid medium is applied, which vortex generator (2) has surfaces extending in the direction of the main flow (1) and surfaces around which flow occurs freely, of which at least two surfaces form side surfaces (3) and (4) supported on the duct wall (6), which side surfaces (3) and (4) converge towards each other in flow direction and meet at an acute angle α in a common edge (7) that forms the downstream edge (7) of the vortex generator (2), and of which at least one surface forms a top surface (5) that in flow direction extends away from the duct wall (6) at an acute angle θ and forms trailing edges (9) and (10) together with the side surfaces (3) and (4), characterized in that the vortex generator (2) has at least one outlet opening (12) for a targeted introduction of a secondary flow (13) into the core flow of the forming wake vortex (11).

2. Vortex generator according to claim 1, characterized in that the at least one outlet opening (12) is located in the area of the side surfaces (3) or (4).

3. Vortex generator according to claim 2, characterized in that the at least one outlet opening (12) is located at half the chord length immediately below the trailing edge (9) or (10).

4. Vortex generator according to claim 2, characterized in that at least one side surface (3) or (4) is equipped with a plurality of outlet openings (12) of a different geometrical configuration, for example with respect to orientation and/or throughput.

5. Vortex generator according to claim 1, characterized in that at least one outlet opening (12) is located at the downstream edge (7) of the vortex generator (2).

6. Vortex generator according to claim 5, characterized in that the downstream edge (7) has a plurality of outlet openings (12).

7. Vortex generator according to claim 6, characterized in that the downstream edge (7) has a plurality of outlet openings with a different geometrical configuration.

8. Vortex generator according to claim 1, characterized in that the at least one outlet opening (12) is constructed with a circular cross-section.

9. Vortex generator according to claim 1, characterized in that the at least one outlet opening (12) is constructed in a slit shape.

10. Method for controlling the wake flow of a vortex generator in a flow duct to which a fluid medium is applied, which vortex generator has essentially three surfaces extending in the flow direction and around which surfaces flow occurs freely, of which surfaces at least two surfaces form side surfaces (3; 4) supported on the duct wall (6), which side surfaces converge towards each other in flow direction and meet at an acute angle α in a common edge (7), and of which at least one surface forms a top surface (5) that in flow direction extends away from the duct wall at an acute angle θ and forms trailing edges (9;10) together with the side surfaces (3;4), whereby the flowing fluid forms a pair of countercurrent vortices (11) downstream from the trailing edges (9;10), the vortex axes of said vortices being in the axis of the main flow (1), characterized in that an axial impulse is introduced in the zone of the core flow of the forming wake vortices (11) at least approximately in the direction of the main flow (1).

11. Method according to claim 10, characterized in that a secondary flow (13) is introduced into the core flow of the wake vortex (11) in a targeted manner.

12. Method according to claim 11, characterized in that a secondary fluid is introduced into the vortex core flow via outlet openings (12) on the vortex generator (2).

13. Method according to claim 12, characterized in that the throughput of the secondary medium (13) is variably adjustable.

14. Method according to claim 11, characterized in that the secondary medium is a component to be mixed into the main flow (1).

15. Method according to claim 11, characterized in that the mass portion of the secondary flow (13) in relation to the main flow (1) is 0.1% to 5%, preferably 0.5% to 1,5%.
